(19) United States
(12) Patent Application Publication
(10) Pub. No.: US 2005/0252556 A1
(43) Pub. Date: Nov. 17, 2005

(54) Control ball valve

(75) Inventors: Alfred Moore Williams, Cypress, TX (US); Lionel J. Milberger, Wheelock, TX (US)

Correspondence Address: BAKER BOTTS, LLP, 910 LOUISIANA, HOUSTON, TX, 77002-4995, US

(73) Assignee: Dril-Quip

(21) Appl. No.: 11/114,500

(22) Filed: Apr. 26, 2005

Related U.S. Application Data
(60) Provisional application No. 60/567,261, filed on Apr. 30, 2004.

(51) Int. Cl. F15B 13/044

(52) U.S. Cl. 137/596.17

(57) ABSTRACT

A control ball valve that includes a flow path is disclosed. The flow path may be capable of coupling the control valve to a subsea operator. The control ball valve comprises a ball and a seat. The ball includes an outer surface, and a portion of the outer surface comprises a spherical surface. The ball also includes a channel that may be part of the flow path. The ball may be capable of rotating about an axis perpendicular to the channel. The seat includes a sealing surface that mates with the portion of the outer surface of the ball to form a seal. The control valve may be included in a pod. Other embodiments of the present invention include combinations of valves and methods for testing and flushing subsea control ball valve assemblies.

### REFERENCE TO PRIOR APPLICATIONS

This application claims the benefit of U.S. Provisional Application No. 60/567,261, filed Apr. 30, 2004.

### BACKGROUND

The present invention relates generally to control valves, and more particularly to, control ball valves for subsea operations.

Conventional valve designs for use in subsea control modules include soft or metal seal poppet and metal shear seal valve designs. Valves based upon these designs have been employed to control the flow of control fluids to hydraulic actuators. Control fluids have typically been water-based fluids. A poppet valve design tends to be employed in applications for which replacement of the valve during the application is acceptable. Poppet valves are also used in low cost applications and/or applications having low flow rates including pilot sections of subsea control valves. Poppet valves have conventionally been used with shallow water subsea blowout preventer (“BOP”) control systems.

Another valve design is a metal shear seal valve. Metal shear seal valves have also been used in applications requiring higher performance and/or low and high flow rates. Metal shear seal valve designs have been commonly used in deepwater BOP control systems and production control systems (“PCS”). BOP systems may require high flow rate valves, whereas PCS systems generally require low flow rate valves. Metal shear seal valves have been problematic because they are susceptible to sea water corrosion and gauling, and they exhibit low reliability.

Both metal seal poppet and metal shear seal valve applications, including PCS applications, may include one or more valves having a pilot valve to operate the main valve stage between the open and closed states or positions of the valves. The pilot valve is usually small in size and flow area. The pilot valve typically requires a very clean control fluid, for example, an NAS 1638 Class 6 or better. If the system fluid is not clean, the pilot valves may become clogged, and consequently, may fail. Pilot valves may also fail due to corrosion that may be induced by sea water contamination. As a result, it may be necessary to continually maintain and monitor fluid cleanliness in the presence of variable operation conditions. Thus, pilot valves may be an unreliable component in a subsea control system and, therefore they may be problematic for equipment suppliers and customers.

Besides fluid cleanliness, another issue in control valve design, especially in subsea applications, is power consumption. Many valves, whether they are slab gate valves, poppet valves, or metal shear sealing valves, require a power source with sufficient energy to change the valve from an open state to a closed state. Subsea control valves that require a low energy source are desirable for system designs because the amount of power required to be delivered is reduced.

### SUMMARY

In one aspect, the present invention is directed to a control ball valve disposed in a flow path coupled to a subsea assembly. The control ball valve includes a ball having an outer surface, at least a portion of which is spherically-shaped, and a channel that is part of the flow path. The control ball valve also includes a drive trunion connected to the ball that rotates the ball between a first position where the channel is aligned with the flow path and a second position where the flow path is not aligned with the flow path. The control ball valve also includes a seat having a sealing surface that mates with the spherically-shaped portion of the outer surface of the ball to form a seal and a carrier seat into which the sealing seat is placed. A spring is also provided, which is disposed within the carrier seat and acts on the sealing seat to force the sealing seat into engagement with the spherically-shaped portion of the ball. The control ball valve further includes an o-ring disposed between the sealing seat and the carrier seat and an o-ring disposed between the carrier seat and a body of the control ball valve.

The control ball valve also includes a ball assembly carrier and a thrust bearing disposed between the drive trunion and the ball assembly carrier that facilitates rotation of the drive trunion relative to the ball assembly carrier. In one embodiment, a rotary solenoid connected to the drive trunion rotates the drive trunion. In another embodiment, an ROV adapter is connected to the drive trunion which enables an ROV to engage the adapter and rotate the drive trunion. In yet another embodiment, an adapter is connected to the drive trunion which is capable of being attached to a manually operated device that can rotate the drive trunion.

In another aspect, the present invention is directed to a control ball valve that includes a first ball having an outer surface, at least a portion of which is spherically-shaped and a channel that is part of the flow path, the first ball having a first position where the channel is aligned with the flow path and a second position where the channel is not aligned with the flow path and a second ball having an outer surface, at least a portion of which is spherically-shaped and a channel that is part of the flow path, the second ball having a first position where the channel is aligned with the flow path and a second position where the channel is not aligned with the flow path. In one embodiment of this aspect of the invention, the control ball valve further includes a drive trunion connected to the first ball and the second ball so that as the trunion rotates it rotates the first ball between its first position and its second position and rotates the second ball between its first position and its second position, wherein when the first ball is in the first position the second ball is in the second position. In another embodiment of this aspect of the invention, the first and second balls are driven independently by first and second rotary solenoids, respectively. The control ball valve may further include an actuator connected to the flow path. In this embodiment, when the first ball is in the first position and the second ball is in the second position pressurized fluid is supplied to the actuator through the first ball and vented through the second ball.

In the second aspect of the present invention, the control ball valve further includes a first seat having a sealing surface that mates with the spherically-shaped portion of the outer surface of the first ball to form a seal and a second seat having a sealing surface that mates with the spherically-shaped portion of the outer surface of the second ball to form a seal. A first carrier seat is also provided into which the first sealing seat is placed and a second carrier seat is provided into which the second sealing seat in placed. The control ball valve also includes a spring, which is disposed within the second carrier seat and acts on the second sealing seat to force the second sealing seat into engagement with the spherically-shaped portion of the second ball. The drive trunion can be rotated either by a rotary solenoid, an ROV, using a manually-operated device or other similar mechanism. The control ball valve may also include an o-ring disposed between the first sealing seat the first carrier seat, an o-ring disposed between the first carrier seat and a body of the control ball valve, an o-ring disposed between the second sealing seat and the second carrier seat, and an o-ring disposed between the second carrier seat and a ball of the control valve.

Another embodiment of the present invention is a method of testing for a leak in a subsea control valve assembly. The subsea control valve assembly may comprise a first valve, a second valve, an actuator, and a flow path. Each valve includes an open and a closed state. Each valve includes an upstream and downstream side. The upstream side of the first valve may be coupled to a pressure source, and the downstream side of the second valve may be coupled to a vent. The flow path may couple the actuator, the downstream side of the first valve, and the upstream side of the second valve. The method may comprise the steps of placing the first valve in the open state, placing the second valve in the closed state, applying pressure to the first valve and thereby causing actuator to open placing the first valve in the second state, and monitoring pressure in the flow path to test for a leak.

Another embodiment of the present invention is a method of flushing a subsea control valve assembly. The subsea control valve assembly may comprise a first valve and a second valve, an actuator, and a flow path. Each valve includes an open and a closed state. Each valve includes an upstream and downstream side. The upstream side of the first valve may be coupled to a pressure source, and the downstream side of the second valve may be coupled to a vent. The flow path may couple the actuator, the downstream side of the first valve, and the upstream side of the second valve. The method may comprise the steps of placing the first valve in the open state, placing the second valve in the open state, and applying hydraulic fluid to the first valve.

### BRIEF DESCRIPTION OF THE DRAWINGS

A more complete understanding of the present disclosure and advantages thereof may be acquired by referring to the following description taken in conjunction with the accompanying drawings wherein:

FIG. 1A is an embodiment of a control valve including upstream sealing according to the present invention;

FIG. 1B is an enlarged view of part of the control valve shown in FIG. 1A;

FIG. 2A is an embodiment of a control valve including downstream sealing according to the present invention;

FIG. 2B is an enlarged view of part of the control valve shown in FIG. 2A;

FIG. 3A is an embodiment of a control valve including bi-directional sealing according to the present invention;

FIG. 3B is an enlarged view of part of the control valve shown in FIG. 3A;

FIG. 4 is an embodiment of a three way valve according to the present invention;

FIGS. 5A is a diagram of a three way valve in the open state according to the present invention having the actuator in the energized position, and 5B is a diagram of a three way valve in the closed state according to the present invention having the actuator in the relaxed position;

FIGS. 6A-6D show multiple configurations for a pair of two way valves having independent solenoid control; FIG. 6A depicts the open state, FIG. 6B depicts the closed state, FIG. 6C depicts the test state, and FIG. 6D depicts the flushing state of the valve;

FIG. 7 is an embodiment of a control valve according to the present invention that may be operated by a remote operating vehicle (ROV);

FIG. 8 is an embodiment of a control valve according to the present invention that may be manually operated;

FIG. 9 depicts a control valve located in a pod for controlling a production control system; and

FIG. 10 depicts a control valve located in a pod for controlling a BOP.

It is to be noted, however, that the appended drawings illustrate only typical embodiments of this invention and are therefore not to be considered limiting of its scope, as the invention may admit to other equally effective embodiments.

### DETAILED DESCRIPTION

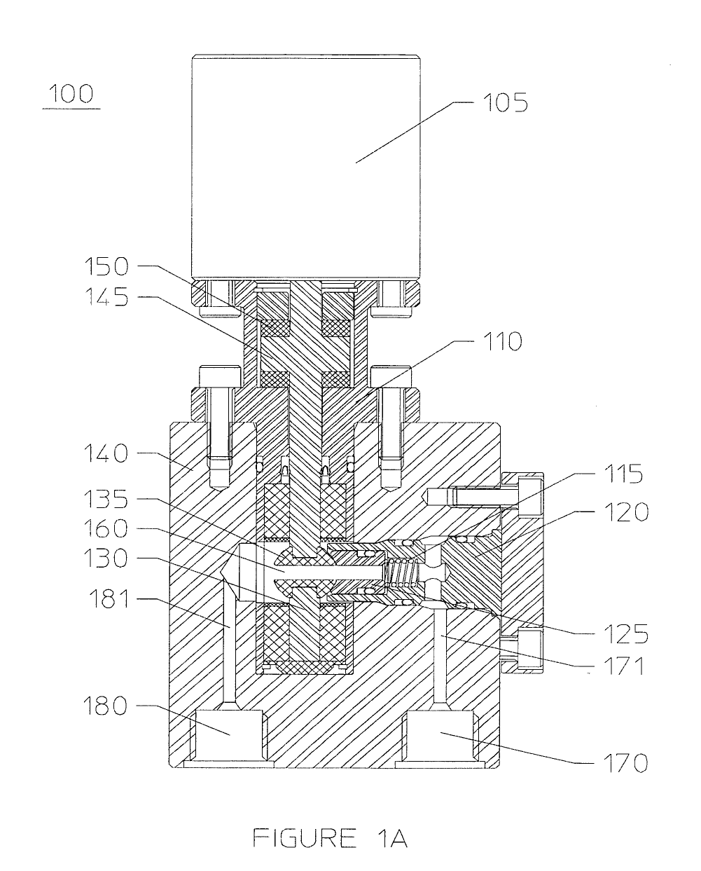

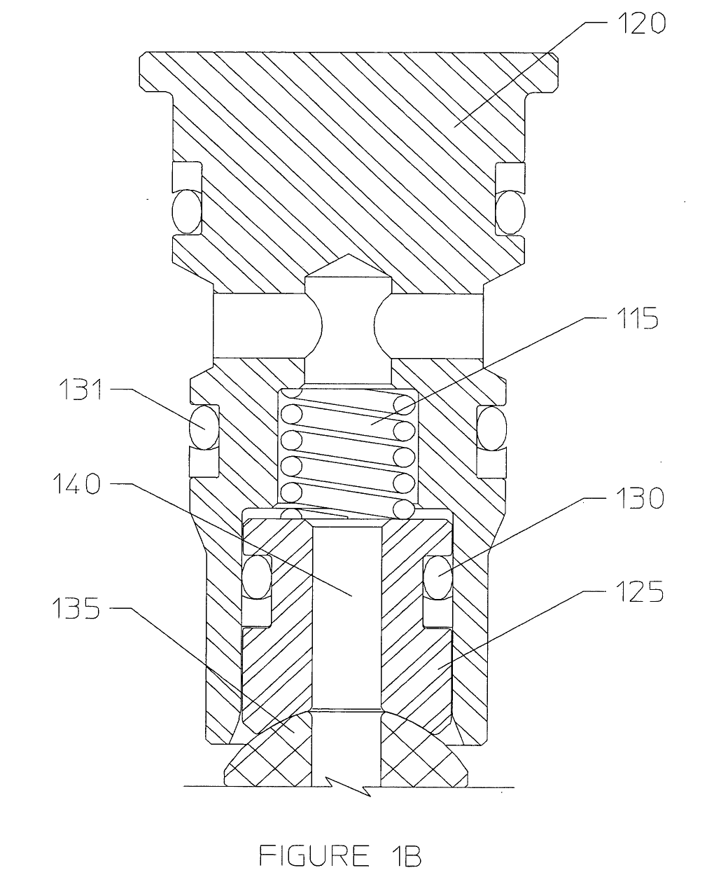

The details of the present invention will now be described with reference to the figures. One example of a control valve according to the present invention is control ball valve 100 shown in FIG. 1A. Control ball valve 100 includes rotary solenoid 105. Rotary solenoid 105 drives drive trunion 145, which is connected to ball 135. An idle trunion 130 is also connected to ball 135 of control ball valve 100. Control ball valve 100 also includes thrust bearing 150, ball assembly carrier 110, spring 115, upstream seat carrier 120, upstream sealing seat 125, and body 140. The upstream sealing seat 125 may also be denoted as seat 125. In one example control valve, spring 115 provides for an initial seal of the valve that is biased open. Thus, a seal at the ball/seat interface is not formed in the absence of upstream pressure from the seat side of the ball/seat interface. Control ball valve 100 includes an upstream port 170 that is coupled to the upstream source of the hydraulic flow path and a downstream port 180 that is coupled to the downstream source of the hydraulic flow path. Ball 135 includes a channel 160 that, in combination with upstream port 170, downstream port 180, and any coupling conduits (e.g., conduits 171 and 181), is part of a flow path for hydraulic fluid.

A sealing surface of the upstream sealing seat 125 mates with a spherical portion of ball 135 to create a seal. Depending on the sealing configuration, a seal may be formed at the interface between ball 135 and upstream sealing seat 125 in response to an application of pressure to the ball or to the seat. Control ball valve 100 is depicted in the upstream sealing configuration. A valve is characterized as being in the upstream sealing configuration if pressure applied to the seat side of the ball creates a seal between the ball and seat interface. In other words, pressure applied to upstream sealing seat 125 causes its surface to mate with a portion of the surface of ball 135. Ball 135 of control valve 100 is depicted in the open state in FIG. 1A. In the open state, ball 135 permits the flow of hydraulic fluid through the hydraulic flow path. In the closed state, ball 135 blocks the flow of hydraulic fluid through the hydraulic flow path. The hydraulic flow path may be connected to a subsea operator. In one implementation, the hydraulic flow path is connected to the subsea operator via an actuator. The subsea operator may include, without limitation, a control gate valve, a cylinder that does work, a down-hole safety valve, a BOP ram, a ball valve, a gate valve, an annular valve, and a wellhead connector.

Ball 135 shown in FIG. 1A includes one channel 160. Channel 160 includes an inlet port into which hydraulic fluid may flow and an outlet port from which hydraulic fluid may flow. In the embodiment of FIG. 1A, ball 135 includes one channel 160 that forms a through-hole that traverses completely through the ball such that a 180 degree rotation of the ball results in ball 135 maintaining its open state. Moreover, a 90 degree rotation of the ball depicted in FIG. 1A about an axis perpendicular to channel 160 changes the orientation of ball 135 from an opened state to a closed state. In one embodiment, solenoid 105 may rotate ball 135 ninety degrees. In another embodiment, solenoid 105 may rotate ball 135 less than 90 degrees so that the solenoid will operate more than once on the ball to effect a change in state.

One of ordinary skill in the art with the benefit of this disclosure will recognize that ball 135 may include more than one channel for hydraulic fluid flow. In another embodiment, ball 135 may include three channels equally spaced around the sphere. The channels may intersect at the center point of ball 135, with one end of each channel being the center point of the sphere and the other end of the channel exiting the surface of the ball 135. Furthermore, each of the channels may be centered about an axis, and the three axes may intersect in approximately a planar region. In this case, a rotation of 120 degrees maintains the open or closed state of ball 135. And a rotation of 60 degrees would change the state of ball 135 from an open to a closed state, or vice versa. In another embodiment, ball 135 may include other channel configurations.

An enlarged view of a portion of control valve 100 is shown in FIG. 1B. The enlarged view includes upstream carrier seat 120, upstream sealing seat 125, spring 115, flow path 140, and ball 135. FIG. 1B also includes o-rings 130 and 131. Applying pressure to the upstream side of the ball valve assembly shown in FIG. 1B seals the interface between the ball and the seat by causing seat 125 to be pressed against, and mate with, a spherical portion of the outer surface of ball 135. Control ball valve 100 shown in FIG. 1B is in the upstream sealing configuration because pressure applied from the upstream side of the hydraulic fluid (e.g., the upstream hydraulic fluid port 170) is capable of forming a seal at the interface between ball 135 and upstream sealing seat 125.

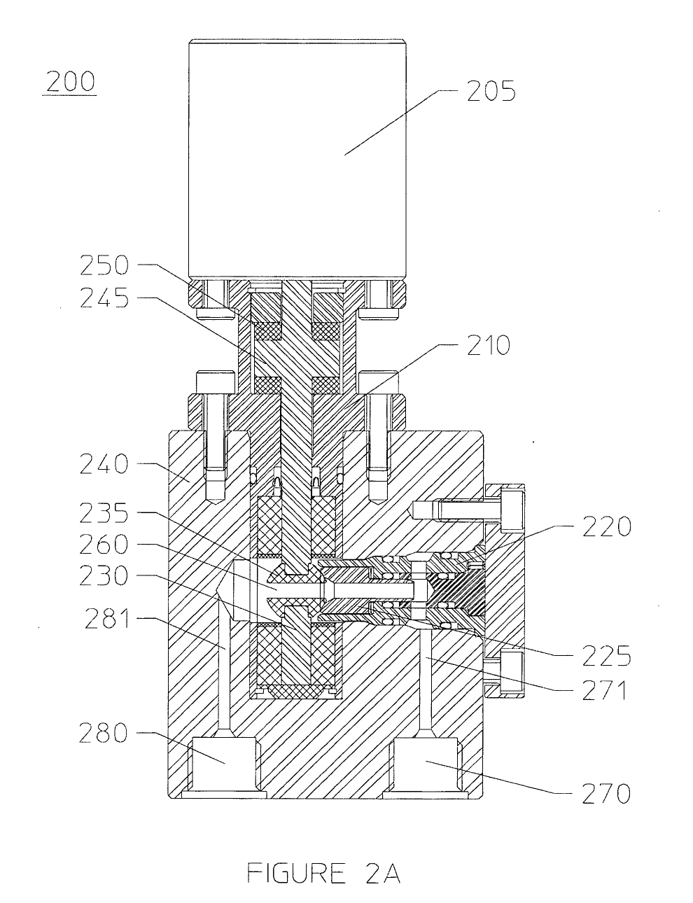

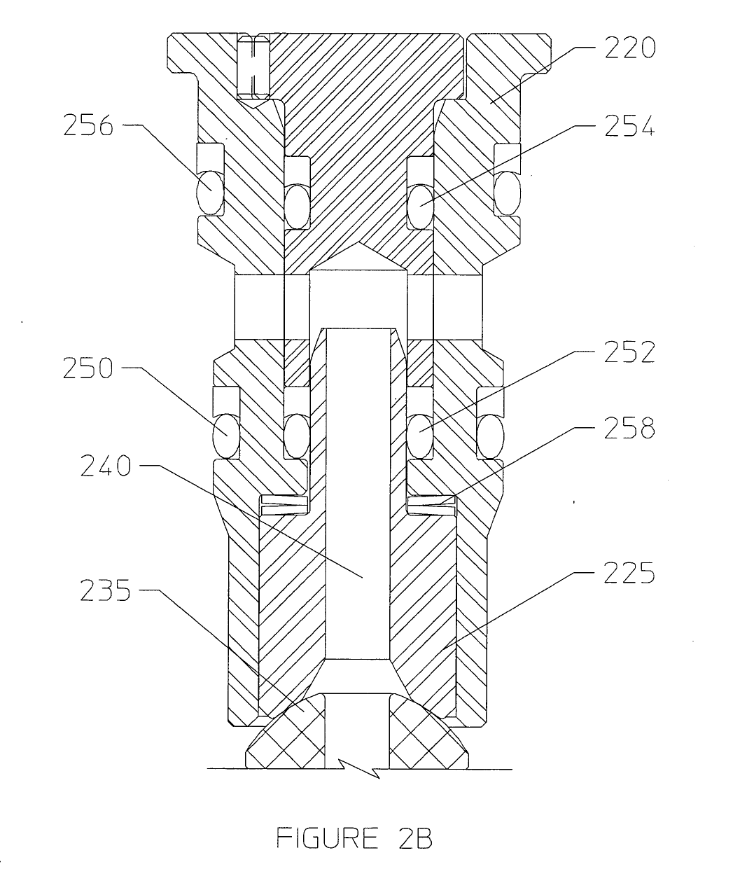

A control valve 200 having a downstream sealing configuration is shown in FIG. 2A. A valve is in the downstream sealing configuration if pressure applied to the ball side of the ball/seat interface forms a seal at the interface. Control ball valve 200 includes rotary solenoid 205, ball assembly carrier 210, upstream seat carrier 220, upstream sealing seat 225, drive trunion 245, idle trunion 230, thrust bearing 250, body 240, and ball 235. Control ball valve 200 also includes upstream hydraulic fluid port 270, downstream hydraulic fluid port 280, and coupling conduits 271 and 281. Control ball valve 200 may be characterized as having a downstream sealing configuration because pressure applied from the downstream side (e.g., pressure applied to ball 235) seals the upstream seat 225 to the ball 235 by causing a sealing surface of upstream seat 225 to mate with a spherical portion of the outer surface of ball 235. As previously noted in FIG. 1A, ball 235 (135) includes a channel 260 (160) through which fluid will flow.

An enlarged view of a portion of control valve 200 is shown in FIG. 2B. The enlarged view shown in FIG. 2B includes ball assembly carrier 220, upstream sealing seat 225, flow path 240, ball 235, o-rings 250, 252, 254, and 256 and washers 258. Control ball valve 200 is shown in the downstream configuration because hydraulic pressure applied to ball causes the upstream sealing seat 225 to seal against ball 235. Because the diameter of o-ring 252 is less than the diameter of upstream sealing seat 225, hydraulic pressure applied from the downstream side of ball 235 forces upstream sealing seat to seal against ball 235.

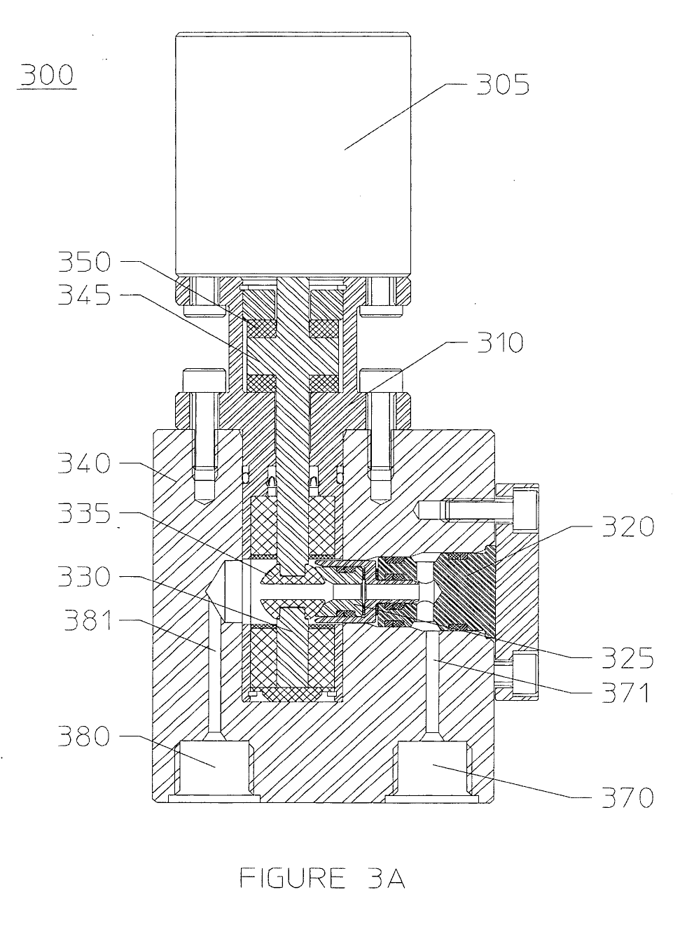

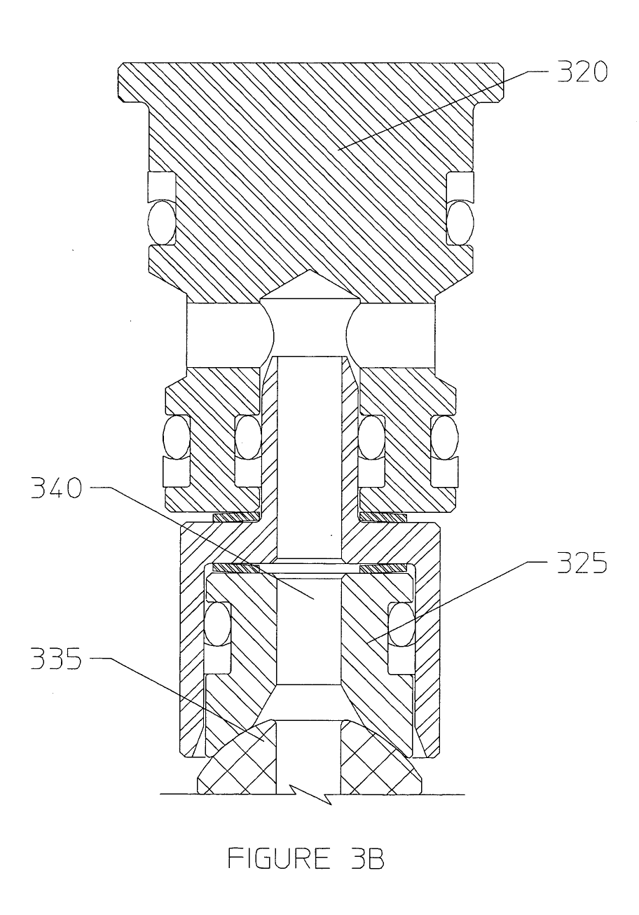

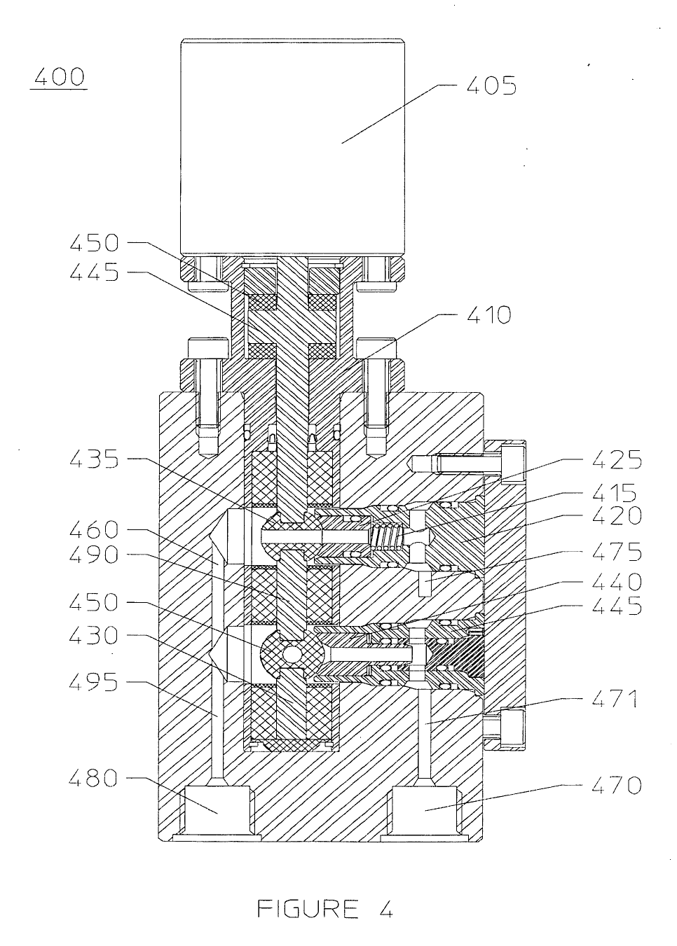

Control valves may also be configured with a bi-directional sealing seat assembly as shown in FIG. 3A. This type of control valve combines the features of upstream and downstream sealing configurations. Control ball valve 300 includes rotary solenoid 305, ball carrier assembly 310, upstream seat carrier 320, upstream sealing seat 325, body 340, thrust bearing 350, drive trunion 345, ball 335, idle trunion 330, upstream hydraulic fluid port 370, downstream hydraulic fluid port 380, and coupling conduits 371 and 381.

An enlarged view of part of control valve 300 is shown in FIG. 3B. FIG. 3B includes upstream seat carrier 320, upstream sealing seat 325, flow path 340, and ball 335. When hydraulic pressure is applied to ball 335 of control valve 300 shown in FIG. 3A and 3B, a sealing surface of the upstream sealing seat 325 mates with a spherical portion of the outer surface of ball 335 to form a seal thereto. Furthermore, when hydraulic pressure is applied to the upstream sealing seat 325 of control ball valve 300, a sealing surface of the upstream sealing seat 325 mates with a spherical portion of the outer surface of ball 335 to form a seal thereto.

Another example of a control ball valve includes a pair of balls and seats comprising a three way valve. In one embodiment, the balls are actuated by a common actuator. The two balls may be placed in opposite states, e.g., one ball is in the open state and the other ball is in the closed state. The actuator may undergo intermittent rotation in a single direction or undergo incremental reverse rotation to achieve a change in the state of the 3-way valve.

FIG. 4 depicts a three way single operator control valve 400 with a common cavity. Control ball valve 400 includes rotary solenoid 405, ball assembly carrier 410, thrust bearing 446, drive trunion 445, and idle trunion 430. Control ball valve 400 includes two balls, 435 and 450. As shown in FIG. 4, ball 435 is in the open state, and ball 450 is in the closed state. Balls 435 and 450 are coupled together by coupling trunion 490. Consequently, rotation of ball 435 causes ball 450 to rotate. The states of balls 435 and 450 are controlled by rotary solenoid 405. Assuming that balls 435 and 450 each have a single channel, a 90 degree rotation of each ball would change the balls from their current states, (e.g., opened or closed) to their opposite states.

Control ball valve 400 also includes upstream carrier seats 420 and 421, upstream sealing seats 425 and 440, and spring 415. The interface between ball 435 and upstream sealing seat 425 of control valve 400 shown in FIG. 4 is depicted in the upstream sealing configuration. The interface between ball 450 and upstream sealing seat 440 is depicted in the downstream sealing configuration. Balls 435 and 450 are coupled to a common flow path 495. Control ball valve 400 also includes a downstream hydraulic flow port 480 coupled to common flow path 495, first upstream hydraulic flow port 470 connected to conduit 471 and the ball assembly that includes ball 450, and second upstream hydraulic flow port (not shown) and conduit 475 connected to the ball assembly that includes ball 435. The second upstream hydraulic flow port may be connected to conduit 475. In one example, the second upstream hydraulic flow port may be similar to first upstream hydraulic flow port 470.

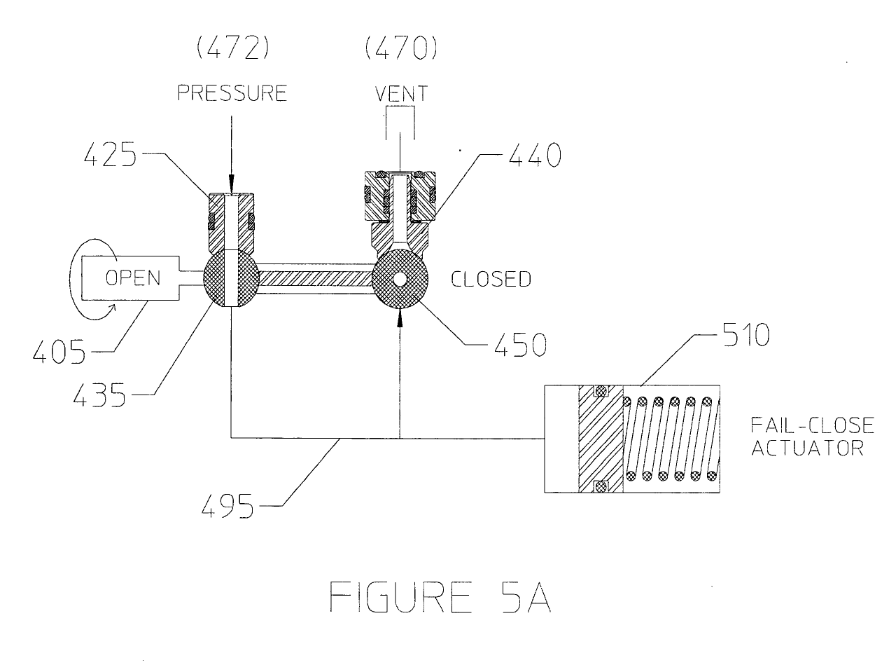

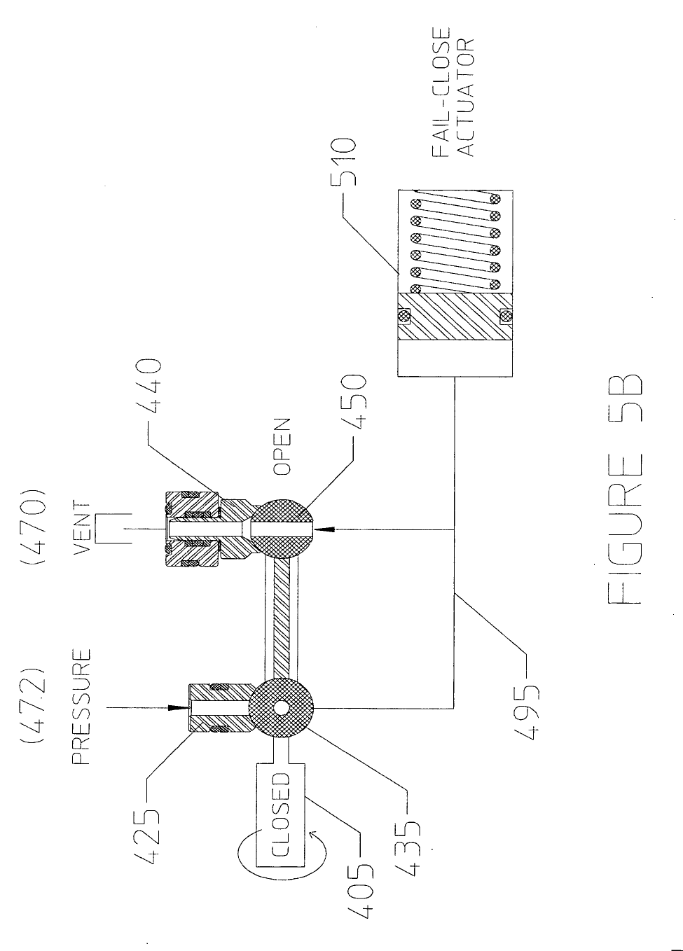

One embodiment of the operation of a three way control valve is shown in FIGS. 5A and 5B. In the configuration of FIGS. 5A and 5B, the second upstream hydraulic port is connected to the hydraulic fluid pressure source, and the first hydraulic port 470 is connected to a vent. The interface seal between ball 435 and seat 425 is shown in an upstream configuration, and the seal between ball 450 and seat 440 is in a downstream configuration. Because ball 435 is in the upstream configuration, the pressure applied to the second upstream pressure port will cause a sealing surface of upstream sealing seat 425 to mate against a spherical outer surface of ball 435, thereby forming a seal thereto. Furthermore, since ball 450 is in the closed state, the pressure on ball 450 will be approximately equal to the pressure exerted on ball 435. Moreover, because ball 450 is in the downstream sealing position, the pressure applied to seat 440 will cause a spherical portion of seat 440 to mate against the sealing surface of the ball 450. As a result, the hydraulic pressure will be applied to actuator 510. If actuator 510 is a fail-close actuator, the actuator will move to its energized state in response to the pressure applied to the three way valve.

FIG. 5B illustrates the situation in which rotary solenoid 405 rotates ball 435 in the closed state and ball 450 in the open state. Because the valve assembly that includes ball 450 is a downstream sealing configuration, the pressure applied to ball 450 will maintain the seal between ball 450 and upstream sealing seat 440. Furthermore, the pressure in flow path 495 will be bled off through the vent. Additionally, with the pressure removed, the fail-close actuator will move to its relaxed state in response to the absence of pressure applied to the actuator.

One of ordinary skill in the art with the benefit of this disclosure will recognize that additional balls may be added to the system shown in FIGS. 5A and 5B. For example, a tandem configuration of three valves could create a four way valve.

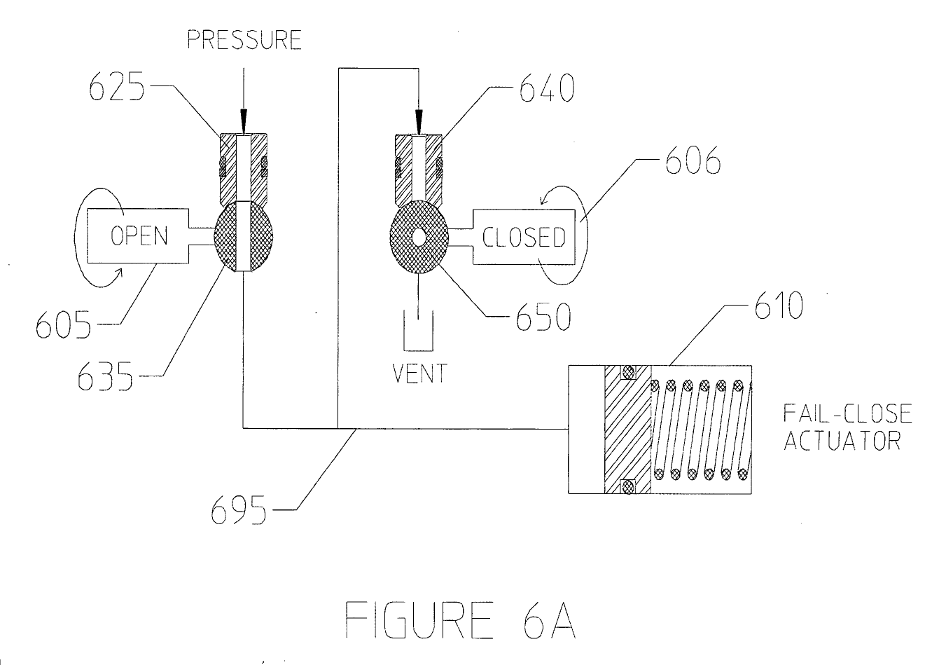

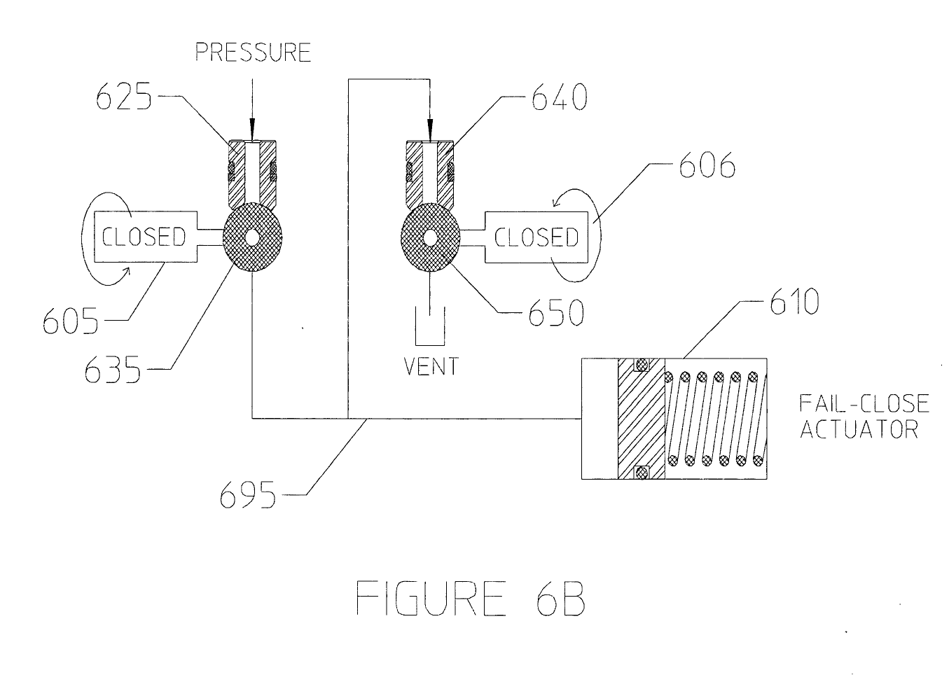

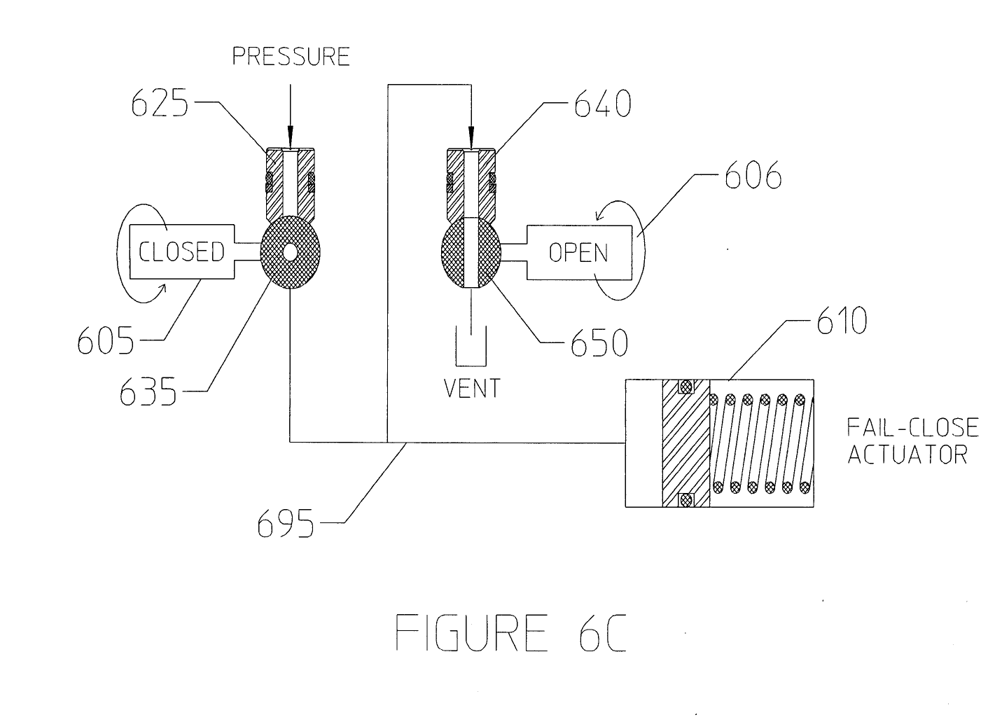

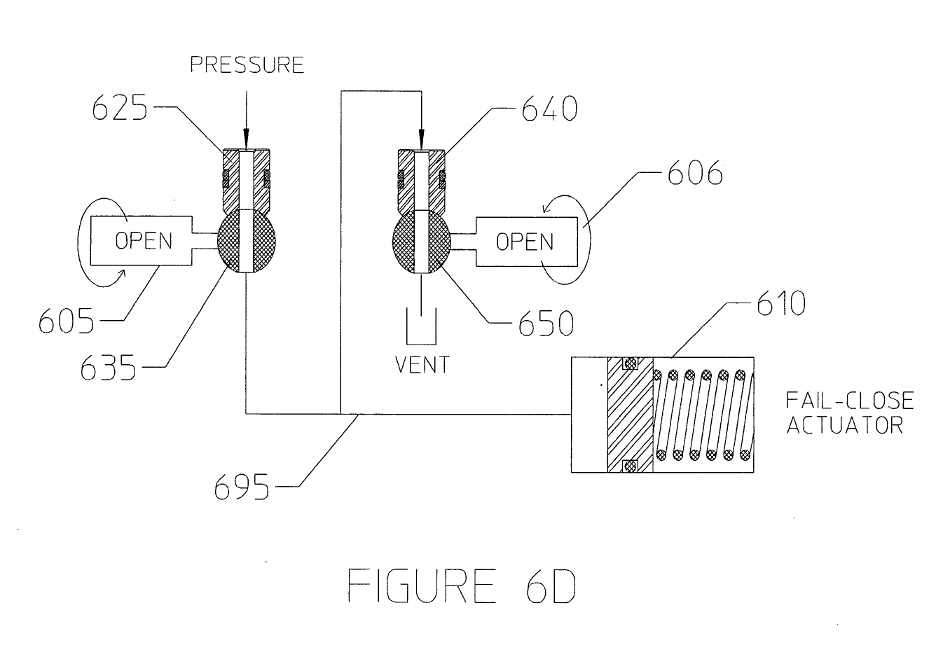

In another embodiment, a pair of two-state, two way valves may be connected as shown in FIGS. 6A-6D to create a four state, three way valve. Each valve includes a solenoid (605 and 606) that when operated changes the valve state. FIG. 6A depicts a ball 635 and an upstream sealing seat 625 in an upstream sealing configuration. FIG. 6A depicts another ball 650 and upstream sealing seat 640. In the example shown in FIG. 6A, flow path 695 couples ball 635, upstream sealing seat 640, and fail-close actuator 610. Additionally, ball 635 is in the open state, whereas ball 650 is in the closed state.

FIG. 6A depicts a four state, three way valve in the open state. Pressure applied to upstream sealing seat 625 seals ball 635 and upstream sealing seat 625 in the example depicted in FIG. 6A. Furthermore, flow path 695 couples the pressure to upstream sealing seat 640, and consequently seals the upstream sealing seat 640 to ball 650. Flow path 695 also couples the pressure to fail-close actuator 610. Because ball 650 is in the closed state, the pressure in flow path 695 causes the fail-close actuator to move to its open state.

FIG. 6B depicts the situation in which solenoid 606 rotates ball 650 from its open state of FIG. 6A to its closed state. In this case, assuming the system has no leaks, pressure is maintained in flow path 695, and fail-close actuator 610 remains in its open state. On the other hand, the presence of a leak in flow path 695, in fail-close actuator 610, or in either of the two independent two way valves (e.g., valves including balls 635 and 650) will manifest itself as a reduction in pressure in flow path 695. As a result, a pressure monitor may be connected to flow path 695 to test for pressure leaks. Moreover, as the pressure in flow path 695 reduces because of a leak in the system, the fail-close actuator 610 will change from an open state to a closed state. Consequently, the valve depicted in FIG. 6B may be characterized being in the test state.

FIG. 6C depicts a four state, three way valve in the closed state. In this case, ball 635 is rotated to its closed state, and ball 650 is rotated to its open state. In its open state, ball 650 is coupled to a vent. As a result, pressure is bled through flow path 695 to the vent. In response to the pressure venting, the fail-close actuator will switch from its open state to its closed state.

Finally, FIG. 6D depicts a four state, three way valve in its flush state. In this case, balls 635 and 650 are rotated to their respective open states. As a result, pressure applied to upstream sealing seat 625 is transferred to the vent through flow path 695. Consequently, the hydraulic system flow path may be flushed and cleaned using the configuration of FIG. 6D.

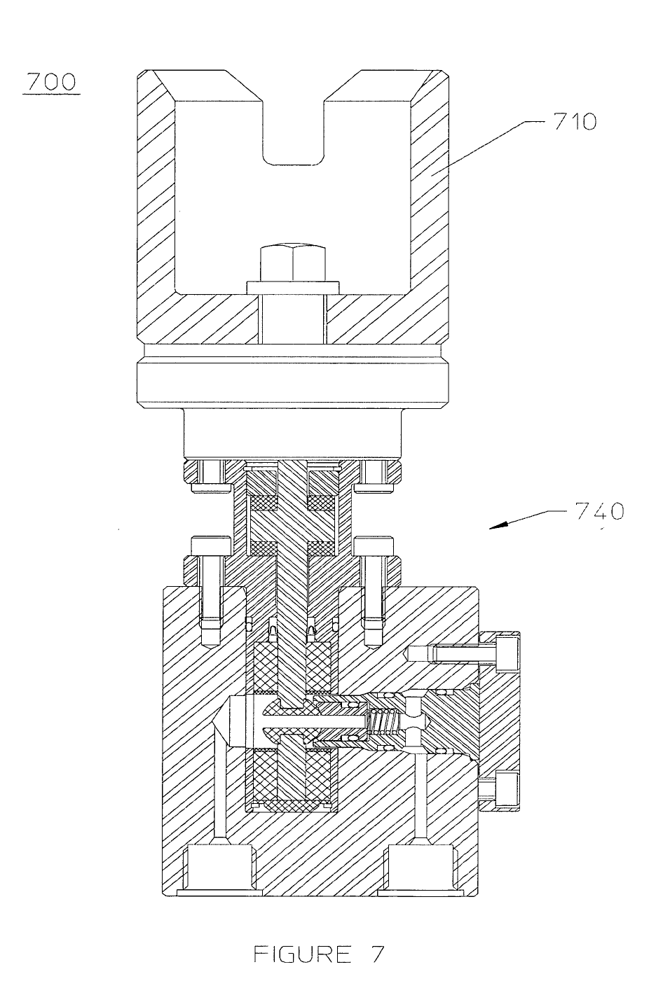

Although the previous embodiments have used an electric solenoid, one skilled in the art with the benefit of this disclosure will recognize that the states of a control valve may be changed by other mechanisms. FIG. 7 shows an embodiment of control ball valve 700 that includes a remote operated vehicle- (“ROV”) based approach for controlling the state of the valve. Control ball valve 700 includes an ROV adapter 710 to which an ROV may attach. The remaining portion of control ball valve 700 is labeled as 740. The portion labeled 740 may be implemented in various fashions, including, without limitation, the examples presented in FIGS. 1-4. One skilled in the art with the benefit of this disclosure will recognize other implementations of 740.

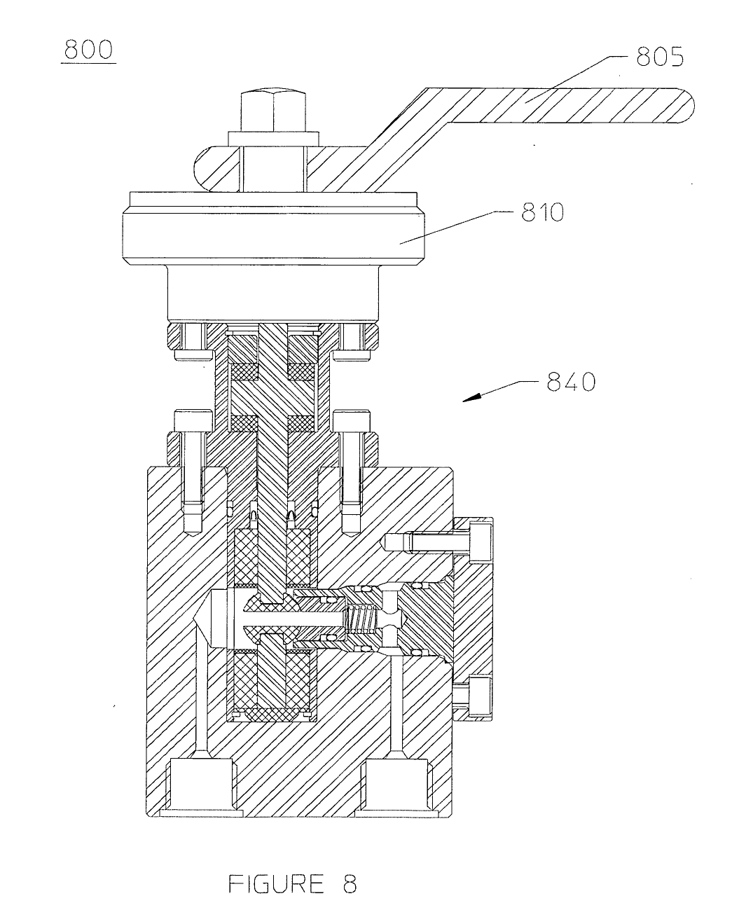

As shown in FIG. 8, the state of a control valve may be manually changed. The control ball valve 800 shown in FIG. 8 includes adapter 810 for attachment to manually-operated operated device 805. In one example, a diver may manually move device 805, and thereby cause a change from an open to a closed position, or vice versa. The remaining portion of control ball valve 800 is labeled as 840. The portion labeled 840 may be implemented in various fashions, including without limitation, the examples presented in FIGS. 1-4. One skilled in the art with the benefit of this disclosure will recognize other implementations of 840.

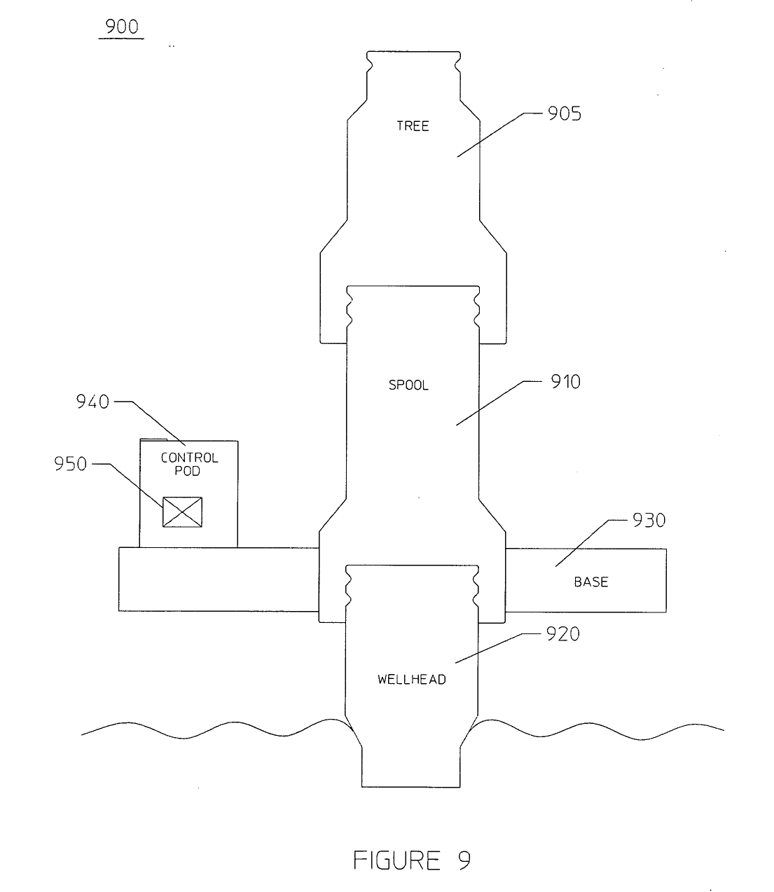

As previously discussed, control valves, including control ball valves, typically may control a variety of subsea operators. In the embodiment depicted in FIG. 9, a control ball valve may control, at least in part, a subsea production control system. In one example, the subsea production system 900 includes tree 905, spool 910, and wellhead 920. The subsea production system also includes base 930 for supporting control pod 940. A control pod is an enclosure that includes valves and/or electronic components. The electronic components may be used, for example, to control valves or other aspects of the production control system. Included within control pod 940 is control ball valve 950. Control pod 940 is an enclosed capsule that may protect control ball valve 950, as well as the electronic components included therein, from corrosion caused by the seawater and other environmental factors. Additionally, control pod 940 is an independent module that may be retrieved and replaced, if necessary. Retrieval and replacement of control pod 940 may be performed without shutting down production of the well.

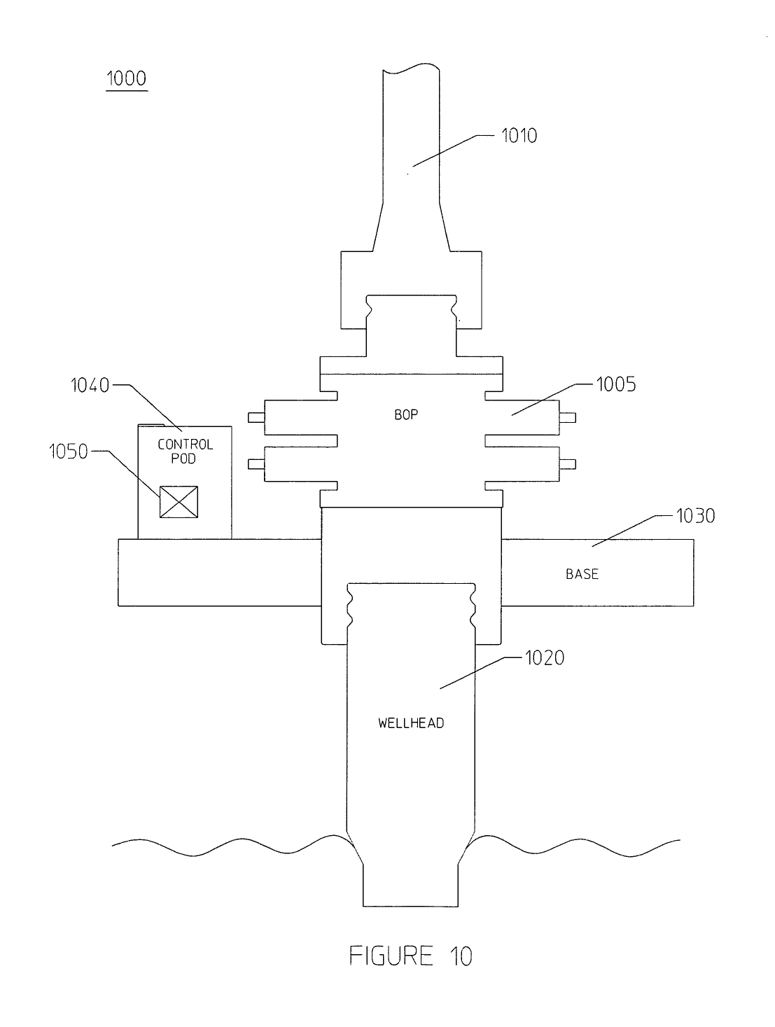

In the embodiment shown in FIG. 10, a control ball valve may control a BOP system, rather than a production control system. BOP system 1000 includes BOP 1005, BOP adapter 1010, and wellhead 1020. BOP system 1000 also includes base 1030 for supporting control pod 1040. A control ball valve 1050 is included in control pod 1040. Similar to the example shown in FIG. 9, control pod 1040 is an independent module that may be retrieved and replaced, if necessary.

Some embodiments of control valves according to the present invention, including control ball valves, may be implemented with a solenoid having a small electrical source. These types of devices may be sufficient to change the state of a control ball valve in one step. In some embodiments, however, a solenoid that produces small incremental rotation on the control ball valve may be used. By reducing the amount of movement produced by the solenoid on the ball, e.g., a solenoid effects a 10 degree movement rather than a 30 degree movement per step, the amount of energy consumed by the solenoid is reduced. Consequently, an electrical source having low power may be used in a control ball valve according to the present invention, thereby resulting in energy conservation.

In one embodiment, the control ball valve is operated in steps by an actuator. Each step contributes to the total of 90 degrees that may be required in one embodiment to change the valve from its open to closed state. The ball may rotate in one direction (e.g., clockwise or counterclockwise). Furthermore, the metal materials are less susceptible to corrosion, due in part, to the inclusion of the valve in a control pod. Additionally, the size of the ball valve flow path may be modified as necessary for various applications. In general, however, the control ball valve according to the present invention may be larger than conventional valve designs.

Conventional valves, including control valves, typically include a small orifice. Because particles in the hydraulic fluid may lead to orifice clogging, these types of valves may require a fluid having a minimum desired cleanliness. For example, some valves may require, at a minimum, a class 6 fluid. A control ball valve according to the present invention does not include a small orifice that may become clogged in the presence of contamination in the hydraulic fluid. Specifically, the ball valve does not require a pilot valve and is not required to operate on NAS 1638 Class 6 clean fluid. Consequently, the cleanliness of the hydraulic fluid need not be as stringent as that for a conventional valve with a small orifice. In one embodiment, the hydraulic fluid may include particles that are of a much larger size than class 6. In another embodiment, a control ball valve of the present invention may be designed to work with a fluid having a cleanliness ranging from about Class 12 to about Class 7.

The invention, therefore, is well adapted to carry out the objects and to attain the ends and advantages mentioned, as well as others inherent therein. While the invention has been depicted, described and is defined by reference to exemplary embodiments of the invention, such references do not imply a limitation on the invention, and no such limitation is to be inferred. The invention is capable of considerable modification, alteration and equivalents in form and function, as will occur to those ordinarily skilled in the pertinent arts and having the benefit of this disclosure. For example, an electric motor may be used in place of a solenoid. Additionally, the control valves may encompass valves other than control ball valves. Furthermore, the control valves need not be limited to subsea applications but may be used in land-based applications. Moreover, the valves of the present invention are not limited to control valves, but may be any type of ball valve. The depicted and described embodiments of the invention are exemplary only, and are not exhaustive of the scope of the invention. Consequently, the invention is intended to be limited only by the spirit and scope of the appended claims, giving full cognizance to equivalents in all respects.

1. A control ball valve disposed in a flow path coupled to a subsea assembly, comprising:
a ball having an outer surface, at least a portion of which is spherically-shaped, and a channel that is part of the flow path;
a drive trunion connected to the ball that rotates the ball between a first position where the channel is aligned with the flow path and a second position where the flow path is not aligned with the flow path; and
a seat having a sealing surface that mates with the spherically-shaped portion of the outer surface of the ball to form a seal.

2. The control ball valve of claim 1, further comprising a carrier seat into which the sealing seat is placed.

3. The control ball valve of claim 2, further comprising a spring, which is disposed within the carrier seat and acts on the sealing seat to force the sealing seat into engagement with the spherically-shaped portion of the ball.

4. The control ball valve of claim 3, further comprising an o-ring disposed between the sealing seat and the carrier seat and an o-ring disposed between the carrier seat and a body of the control ball valve.

5. The control ball valve of claim 1, further comprising a fluid port located in the flow path upstream from the channel and connected to the channel via a coupling conduit and a fluid port located downstream from the channel and connected to the channel via a coupling conduit.

6. The control ball valve of claim 1, further comprising a ball assembly carrier and a thrust bearing disposed between the drive trunion and the ball assembly carrier that facilitates rotation of the drive trunion relative to the ball assembly carrier.

7. The control ball valve of claim 1, further comprising a rotary solenoid connected to the drive trunion, which rotates the drive trunion.

8. The control ball valve of claim 1, further comprising an ROV adapter connected to the drive trunion.

9. The control ball valve of claim 1, further comprising an adapter connected to the drive trunion which is capable of being attached to a manually operated device.

10. A control ball valve disposed in a flow path coupled to a subsea assembly, comprising:
a first ball having an outer surface, at least a portion of which is spherically-shaped, and a channel that is part of the flow path;
a second ball having an outer surface, at least a portion of which is spherically-shaped, and a channel that is part of the flow path; and
a drive trunion connected to the first ball and the second ball so that as the trunion rotates it rotates the first ball between a first position where the channel is aligned with the flow path and a second position where the channel is not aligned with the flow path and rotates the second ball between a first position where the channel is aligned with the flow path and a second position where the channel is not aligned with the flow path, wherein when the first ball is in the first position the second ball is in the second position.

11. The control ball valve of claim 10, further comprising a downstream flow port coupled to a common section of the flow path and an upstream flow port connected to a section of the flow path passing through the first ball and an upstream flow port connected to a section of the flow path passing through the second ball.

12. The control ball valve of claim 10, further comprising:
a first seat having a sealing surface that mates with the spherically-shaped portion of the outer surface of the first ball to form a seal; and
a second seat having a sealing surface that mates with the spherically-shaped portion of the outer surface of the second ball to form a seal.

13. The control ball valve of claim 12, further comprising:
a first carrier seat into which the first sealing seat is placed; and
a second carrier seat into which the second sealing seat in placed.

14. The control ball valve of claim 12, further comprising a spring, which is disposed within the second carrier seat and acts on the second sealing seat to force the second sealing seat into engagement with the spherically-shaped portion of the second ball.

15. The control ball valve of claim 10, further comprising a rotary solenoid connected to the drive trunion, which rotates the drive trunion.

16. The control ball valve of claim 10, further comprising an ROV adapter connected to the drive trunion.

17. The control ball valve of claim 10, further comprising:
an o-ring disposed between the first sealing seat the first carrier seat;
an o-ring disposed between the first carrier seat and a body of the control ball valve;
an o-ring disposed between the second sealing seat and the second carrier seat; and
an o-ring disposed between the second carrier seat and the body of the control ball valve.

18. A control ball valve disposed in a flow path, the control valve comprising:
a first ball having an outer surface, at least a portion of which is spherically-shaped and a channel that is part of the flow path, the first ball having a first position where the channel is aligned with the flow path and a second position where the channel is not aligned with the flow path;
a second ball having an outer surface, at least a portion of which is spherically-shaped and a channel that is part of the flow path, the second ball having a first position where the channel is aligned with the flow path and a second position where the channel is not aligned with the flow path; and
an actuator connected to the flow path.

19. The control ball valve of claim 18, further comprising a drive trunion connected to the first ball and the second ball so that as the trunion rotates it rotates the first ball between its first position and its second position and rotates the second ball between its second position and its first position, respectively.

20. The control ball valve of claim 18, further comprising:
a first rotary solenoid connected to the first ball, which rotates the first ball between its first position and its second position; and
a second rotary solenoid connected to the second ball, which rotates the second ball between its first position and its second position.
